(19) United States
(12) Patent Application Publication
(10) Pub. No.: US 2013/0067531 A1
(43) Pub. Date: Mar. 14, 2013

(54) Access Brokering Based on Declarations and Consent

(71) Applicants: Max Glenn Morris, Seattle, WA (US); Narayanan Ganapathy, Redmond, WA (US); Darren R. Davis, Woodinville, WA (US); David A. Goll, Seattle, WA (US); Paul Sliwowicz, Seattle, WA (US); George Evangelos Roussos, Seattle, WA (US); Rouella J. Mendonca, Redmond, WA (US)

(72) Inventors: Max Glenn Morris, Seattle, WA (US); Narayanan Ganapathy, Redmond, WA (US); Darren R. Davis, Woodinville, WA (US); David A. Goll, Seattle, WA (US); Paul Sliwowicz, Seattle, WA (US); George Evangelos Roussos, Seattle, WA (US); Rouella J. Mendonca, Redmond, WA (US)

(73) Assignee: MICROSOFT CORPORATION, Redmond, WA (US)

(21) Appl. No.: 13/230,611

(22) Filed: Sep. 12, 2011

(51) Int. Cl. G06F 21/00

(52) U.S. Cl. 726/1; 726/16

(57) ABSTRACT

Embodiments include processes, systems, and devices for brokering application access to capabilities, such as device capabilities. An access broker receives requests from applications to access capabilities. The access broker determines whether to grant access based at least in part on whether the application manifest declares the capability. The access broker also may cause a user interface element to be displayed requesting user consent to the access request. Also, an in-application user interface element is provided that displays capability access settings for a particular application. The in-application user interface element includes selectable options for changing those settings. Changes in those settings via the user interface update the settings in the access broker.

### RELATED APPLICATIONS

This application is related to U.S. application Ser. No. 13/099,260 filed by Ganapathy et al. on May 2, 2011 and entitled “BINDING APPLICATIONS TO DEVICE CAPABILITIES.”

### BACKGROUND

Hardware devices installed on computing systems provide various capabilities such as printing, device administration, location services, messaging, video capture, and so forth. Installed applications access these and other capabilities to provide functionality to the computing system. But it is possible for an application to access potentially risky capabilities without the user's consent or knowledge. For example, there are existing exploits that target location services, messaging services, and others. These exploits can compromise a user's privacy or cause the user to be charged by their network provider without the user's knowledge or consent.

Even where there is no nefarious intent on behalf of an application developer, application access to potentially risky capabilities can unintentionally compromise the security of the computing system or the user's privacy. And even where the user is allowed to consent to capability access by an application, it can be difficult for the user to understand—and it can be difficult to explain to the user—in what contexts the application will access the capability. The user may not realize the ramifications of allowing an application to access a particular capability. The user may therefore either under-permit or over-permit application access to capabilities, thereby potentially undermining the user experience or compromising the user's privacy and security.

### BRIEF SUMMARY

This Summary is provided in order to introduce simplified concepts of capability brokering services, which are further described below in the Detailed Description. This summary is not intended to identify essential features of the claimed subject matter, nor is it intended for use in determining the scope of the claimed subject matter.

An access broker controls application access to computing system capabilities, such as hardware device capabilities. The access broker receives requests from applications for access to capabilities and applies a policy to determine whether to grant the access. The policy may require that the application have an application manifest that declares the capability in order for the application to be granted access to the capability. Also, the policy may require that a user consent to the request in order for the application to be granted access to the capability.

A user interface component provides user interfaces that include application-specific capabilities settings, as well as selectable options to change those settings. These user interfaces are launched during user interaction with the application, thereby providing the user with a single location to view and configure capability settings for a particular application. Because these user interfaces are operating system interfaces, the user is provided with a greater measure of confidence that the operating system is controlling application access to potentially risky capabilities.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example system usable to provide an access broker service.

FIG. 2 is a block diagram of an example computing device usable to provide an access broker service according to embodiments.

FIG. 3 is a flow diagram showing an example process for brokering a capability access based on application declarations and user consent.

FIG. 4 is a flow diagram showing an example process for providing in-application capabilities interface settings configuration.

FIG. 5 is a flow diagram showing an example process for viewing and configuring capability-specific settings.

FIG. 6 illustrates an exemplary user interface display for obtaining user consent to an application request for a sensitive capability.

FIG. 7 illustrates an exemplary application acquisition user interface display including a display of capabilities.

FIG. 8 illustrates an exemplary user interface display for displaying in-application capability settings information.

FIG. 9 illustrates an exemplary user interface display for displaying capability-specific settings information.

### DETAILED DESCRIPTION

### Overview

As discussed above, applications access various capabilities in order to provide functionality to users. Some of those capabilities—such as device location, messaging, video capture, internet access, and others—are potentially risky, and a user may want to control or prohibit access to them. Also, users need to be able to determine what capabilities an application is configured to access so that the user can determine whether or not to acquire or execute the application.

In embodiments, an access broker controls application access to capabilities, such as device capabilities. Applications running inside a protected application container request access to capabilities through the access broker. Based on the type of policy that applies to the capability being requested, the access broker takes steps to enforce the policy on a per-application basis. For example, a policy of the access broker may indicate that user consent is to be obtained in order for an application to be granted access to a capability. The policy may indicate that a capability requires an application to declare the capability in its application manifest in order for the application to be granted access to the capability. The policy may require that an application be specifically identified in a privileged permission record as being allowed to access a particular capability in order for the application to be granted access to the particular capability (see U.S. application Ser. No. 13/099,260 filed by Ganapathy et al. on May 2, 2011 and entitled “BINDING APPLICATIONS TO DEVICE CAPABILITIES” for details regarding access brokering using privileged permission records).

Thus, depending on the policy type that applies to a particular capability, the access broker may cause a user interface element to be displayed with a selectable option to consent to the capability. This user interface element is displayed by the operating system in the context of the user's interaction with the application. This makes it easier for the user to understand when and why the application will access the capability.

In embodiments, the user is provided with the option of calling an operating system user interface element while in the context of interacting with an application. The operating system user interface element shows the capabilities that the application is able to access. The user interface element allows the user to enable or disable access to various capabilities. This application-specific view gives the user a single place to view all capabilities, such as device capabilities, that the application can access without having to open multiple configuration pages to determine what capabilities the application is able to access.

In embodiments, an operating system settings module provides the user with a view of all applications that can access a particular capability. This capability-specific view allows the user to control access on a per-application or global basis, thereby further enhancing the user experience. The combination of these features—user consent, capability declarations in the application manifest, application-specific capability configuration, and capability-specific configurations settings—provide the user with a greater measure of confidence that application access to potentially risky capabilities is adequately controlled.

Throughout this Detailed Description, the term “configured”—when used to describe capability functions of an application—means that the application is programmed with functionality to access a particular capability, such as a device capability of a hardware device. Throughout this Detailed Description, the term “enabled”—when used to describe capability functions of an application—means that the application is allowed or permitted to access the capability. An application may therefore be “configured” to access a certain capability while at the same time be not “enabled” to access the same capability.

The processes, systems, and devices described herein may be implemented in a number of ways. Example implementations are provided below with reference to the following figures.

### Example Environment for Providing an Access Broker Service

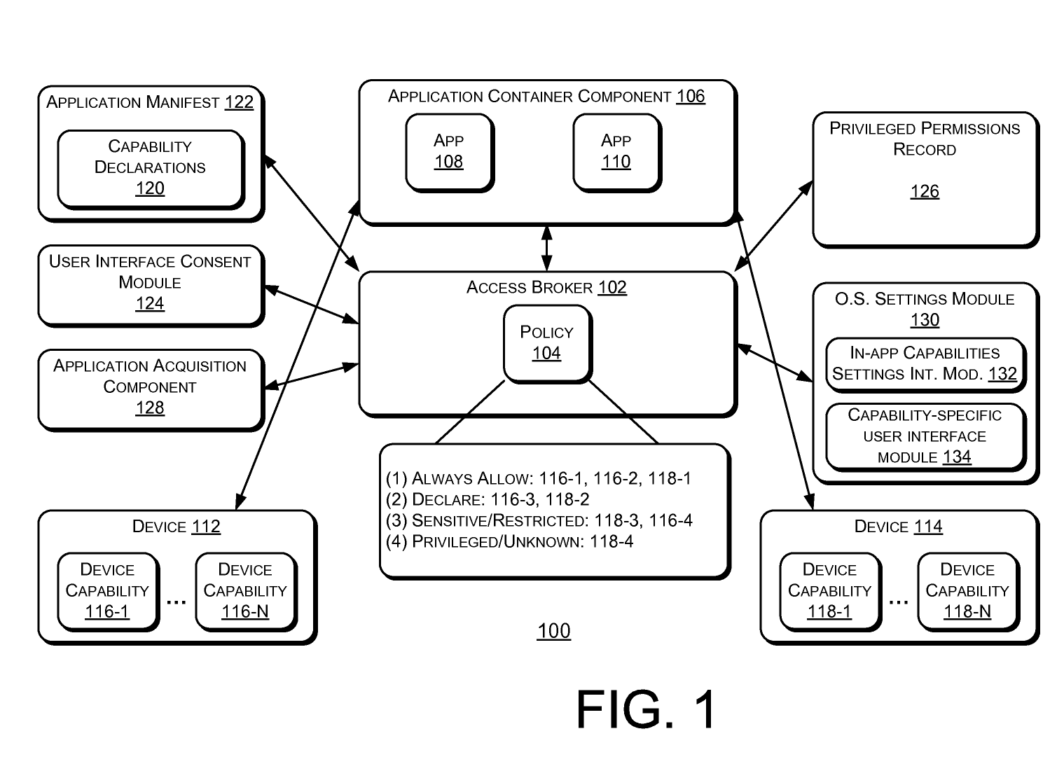

FIG. 1 is a schematic diagram of an example system 100 usable to provide an access broker service. The system 100 may be implemented on various suitable computing device types that are capable of implementing an access broker service. Suitable computing device or devices may include, or be part of, one or more personal computers, servers, server farms, datacenters, special purpose computers, tablet computers, game consoles, smartphones, combinations of these, or any other computing device(s) capable of storing and executing all or part of a device broker service.

In the illustrative example of FIG. 1, the system 100 includes an access broker 102. The access broker 102 includes policy 104, which includes lists of capabilities that fall under various access levels. Example access levels include “always allow”, “declare”, “sensitive/restricted”, and “privileged/unknown”. These example levels are used herein for the sake of discussion, and should not be taken in a limiting sense. In various embodiments, access levels may be sub-levels of other access levels. In one non-limiting example, a capability may fall under both “declare” and “sensitive/restricted.” In another non-limiting example, a capability may fall under both “sensitive/restricted” and “privileged.”

An application container component 106 provides capabilities to enforce the execution of applications in a secure execution mode that controls application access to various system resources, such as memory, applications, application programming interfaces (APIs), or devices. The applications 108 and 110 are configured to execute in the secure mode enforced by the application container component 106. These applications include various functions configured to interact with various devices of the system 100, such as a device 112 and a device 114. The device 112 is enabled to provide various capabilities, such as the device capabilities 116-1 through 116-N. And the device 114 is enabled to provide various capabilities, such as the device capabilities 118-1 through 118-N. Non-limiting examples of device capabilities include location services (such as global positioning system (GPS) services), messaging services (such as short message service (SMS)), video capture services, and others.

The policy 104 lists various capabilities of the devices 112 and 114 under various access levels. For example, the device capabilities 116-1, 116-2, and 118-1 are listed under “always allow”, the device capabilities 116-3 and 118-2 are listed under “declare”, the device capabilities 118-3 and 116-4 are listed under “sensitive/restricted”, and the device capability 118-4 is listed under “privileged”.

The access broker 102 is configured to receive requests from the applications 108 and 110 to access various capabilities of the devices 112 and 114. In a first example, the application 110 requests access to the device capability 116-1 of the device 112. The access broker 102 performs a look-up operation to the policy 104 and determines that the device capability 116-1 falls under the “always allow” level. As a result, the access broker 102 provides a device handle to the application 110 to access the device capability 116-1. The application 110 can then utilize the handle to interact with the device capability 116-1, including sending and receiving data and commands. Capabilities that fall under the “always allow” level are considered the least-risky. In one non-limiting example, printing services may be listed under “always allow” or equivalent access level.

In a second example, the access broker 102 receives a request from the application 108 to access a capability, such as the device capability 118-2 of the device 114. The access broker 102 performs a look-up operation to the policy 104 and determines that the device capability 118-2 falls under the “declare” access level. The access broker 102 therefore determines whether the device declarations 120 within an application manifest 122 that is associated with the application 108 includes a declaration that the application 108 is enabled to access the device capability 118-2 of the device 114. The device declarations 120 may include a “friendly” name for the capability such as “SMS messaging” or “video capture,” as well as a unique identifier for the capability, such as a globally unique identifier (GUID). Upon a determination that the declaration is present in the application manifest 122, the access broker 102 will provide the application 108 with a device handle usable to access the device capability 118-2 of the device 114. Upon a determination that the declaration is not present in the application manifest 122, the access broker returns an exception handle (or some other error message or code) to the application 108, thereby denying the access request. Providing that an application include certain capabilities in its manifest in order to allow the application to access those capabilities requires that the application be up-front about the fact that it is configured to access those capabilities. This in turn allows users to determine whether to access, obtain, download, install, and/or execute an application with knowledge of the capabilities—including device capabilities—that the application is configured to access.

In a third example, the application 108 requests access to a capability, such as the device capability 116-4 of the device 112. The access broker 102 performs a look-up operation to the policy 104 and determines that the device capability 116-4 falls under the “sensitive/restricted” level. As a result, the access broker 102 causes a user interface consent module 124 to display a user interface with a selectable option to consent to the access request. Upon receipt of input indicating user consent to the request (or upon a determination that user consent was previously provided), the access broker 102 provides the application 108 with a device handle usable to interact with an instance of device capability 116-4. In embodiments, the policy 104 may provide that capabilities that fall under the “sensitive/restricted” level also be declared in the application manifest (in addition to user consent) in order to provide access to those capabilities.

In a fourth example, the application 110 requests access to a capability, such as the device capability 118-4 of the device 114. The access broker 102 performs a look-up operation to the policy 104 and determines that device capability 118-4 falls under the “privileged” level. As a result, the access broker 102 performs a look-up to a privileged permissions record 126 to determine whether the application 110 is specifically listed therein as being allowed to access the device capability 118-4. (See U.S. application Ser. No. 13/099,260 filed by Ganapathy et al. on May 2, 2011 and entitled “BINDING APPLICATIONS TO DEVICE CAPABILITIES” for details regarding access brokering using privileged permission records.)

In the examples described above, the requests to access capabilities are for specific capabilities of specific devices. In embodiments, applications may request access to generic capabilities, and the access broker 102 may determine which devices, if any, provide the generic capability. For example, there may be more than one webcam installed on a user's computing device, and the access broker 102 brokers access to one webcam or the other (perhaps prompting the user to choose one) after receiving a request from an application to access a webcam. The access broker 102 also checks to make sure that the computing system includes a webcam before proceeding.

System 100 includes an application acquisition component 128, which provides an interface to an online or offline store to acquire applications, such as the application 108 and the application 110. When presenting an option to acquire the application 108, for example, the application acquisition component 128 is configured to cause display of the capability declarations 120 within the application manifest 122 associated with the application 108. Thus, the user can determine whether to acquire the application based in part on those capabilities that the application 108 is configured to access.

System 100 includes an operating system settings module 130, which includes an in-application capabilities settings interface module 132 and a capability-specific user interface module 134. The operating system settings module 130 is configured to accept user input to display the in-application capabilities settings interface module 132 in the context of user interaction with an application. The in-application capabilities settings interface module 132 provides a configurable list of capability access settings. The in-application capabilities settings interface module 132 lists capabilities that the application is configured to access, whether those capabilities are currently enabled for that application, and also selectable options to enable or disable those capabilities for the application.

For example, in the context of interacting with the application 108, the user may request display of the in-application capabilities settings interface module 132. The in-application capabilities settings interface module 132 may subsequently receive user input to disable the application's 108 access to the device capability 118-3 of the device 114. Thus, even if the user had previously consented to allow the application 108 to access the device capability 118-3 of the device 114, the access broker 102 may revoke current access and deny further requests from the application 108 for the device capability 118-3 or, alternatively, require that the user consent to future requests from the application 108 to access the device capability 118-3.

The operating system settings module 130 is configured to cause the capability-specific user interface module 134 to display. The capability-specific user interface module 134 causes display of a user interface element that lists applications that are configured to access a particular capability. The user interface element also includes a selectable option to disable or enable the capability for all or any applications configured to access it.

In embodiments, one or more capabilities may be known to the operating system at the time of its implementation. In embodiments, the operating system may enable extension of the set of supported capabilities via one or more declarative processes. In some cases the ability to add to the capabilities set may be restricted to the operating system, while in other cases the operating system may allow third-party providers, such as third-party devices, to declare new capabilities. (See to U.S. application Ser. No. 13/099,260 filed by Ganapathy et al. on May 2, 2011 and entitled “BINDING APPLICATIONS TO DEVICE CAPABILITIES” for details regarding extending the capability set.)

In various embodiments, device capabilities are represented generically in terms of the device within which they are implemented. Such embodiments enable users to select devices that are allowed to be used by the application. By doing so, the user consents for the application to use all capabilities of the device. For example a multifunction device connected to a user's computer may be a cell phone that supports SMS capability, a geolocation capability, and a custom capability defined by the cell phone manufacturer. In a device-based model the user is given the opportunity to permit the application to access all capabilities of the device. Alternate embodiments may provide a model for adding user experience metadata associated with specific capabilities such that the user is allowed to enable individual capabilities of the device rather than all capabilities of the device. Thus, in one instance, the user could choose to allow the application to access the SMS capability and the custom capability (such as for example where the manufacturer has provided user interface elements to describe the custom capability), but not the geolocation functionality.

In a non-limiting example of access brokering, a user acquires a media player application and the application acquisition component 128 causes display of capabilities that the media player is configured to access, such as audio and video capture, short messaging service (SMS), and so forth. These capabilities are listed in an application manifest (such as the application manifest 122) that is associated with the media player application. The interface presented by the application acquisition component 128 therefore allows the user to choose whether to acquire the media player application based in part on the capabilities that the media player application is configured to access. These capabilities may be provided by various devices, such as a webcam, microphone, and/or cell phone. Alternatively, one or more of these capabilities may be provided by a web-based service or by a software module executing on the user's computing device.

Continuing with the non-limiting example, the user may later select a function of the media player application configured to send a playlist to another user via in a short messaging service (SMS) message. If the policy 104 provides that SMS messaging capabilities require user consent (such as for example because SMS messaging falls under a “sensitive/restricted” level), then the access broker 102 causes the user interface consent module 124 to display a selectable option to consent to allow the media player application to access the SMS capability. Because the display of the selectable option to consent comes during the context of sending the playlist via SMS, the user can better tell when and why the media player application will access the SMS capability. By contrast, if the user were prompted to allow the media player to access SMS capabilities at the time that the application is launched, when the application is installed, or not at all, then the user may become confused as to when and why the media player accesses SMS. Because the user interface consent module 124 is an operating system element (rather than an element of the media player application), the user can have greater confidence that the media player application will not access potentially risky capabilities like SMS without the user's consent, knowledge, and control.

If the access broker 102 were to receive a subsequent request from a different application to access the SMS capability, the user's previous consent for the media player application to access the SMS capability would not apply, and the access broker 102 would prompt the user to consent to the other application's access of the SMS capability. If the media player application were to request access to a different capability, such as for example location services, then the user's previous consent to allow the media player access to the SMS capability would not apply, and the access broker 102 would prompt the user to consent to the media player's request to access location services.

Continuing further with the non-limiting example, the in-application capabilities settings module 132 causes display of application-specific capability settings while in the context of interacting with the media player application. The user is able to control the media player's SMS capability access using this application-specific view. The capability-specific user interface module 134 provides the user with the option of viewing those applications, such as the media player application, that can access SMS capabilities in a single list, and to turn on or off SMS capability access to any and all applications that the user desires. Thus, embodiments of the present Detailed Description provide the user with greater confidence that the user's computing system is properly controlling the media player application's access to capabilities, such as device capabilities.

### Example Computing Device

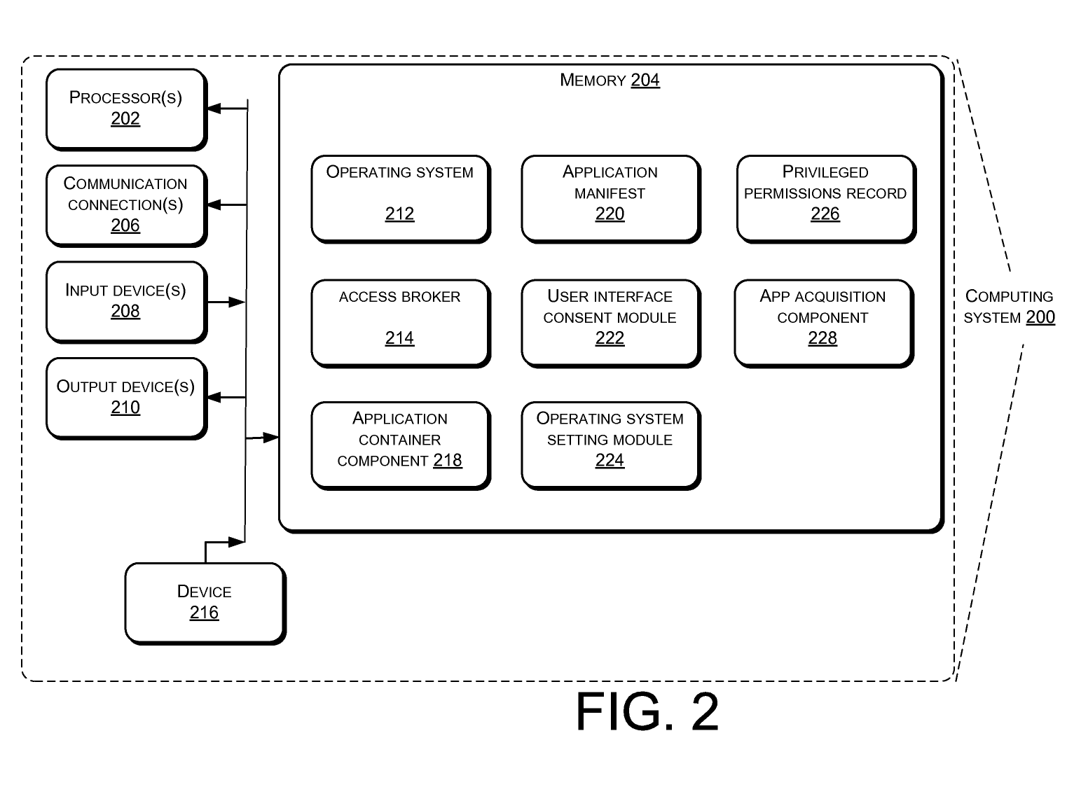

FIG. 2 is a block diagram of an example computing system usable to provide an access broker service according to embodiments. The computing system 200 may be configured as any suitable computing device capable of implementing an access broker service. According to various non-limiting examples, suitable computing devices may include personal computers (PCs), servers, server farms, datacenters, special purpose computers, tablet computers, game consoles, smartphones, combinations of these, or any other computing device(s) capable of storing and executing all or part of an broker service.

In one example configuration, the computing system 200 comprises one or more processors 202 and memory 204. The computing system 200 may also contain communication connection(s) 206 that allow communications with various other systems. The computing system 200 may also include one or more input devices 208, such as a keyboard, mouse, pen, voice input device, touch input device, etc., and one or more output devices 210, such as a display, speakers, printer, etc. coupled communicatively to the processor(s) 202 and memory 204.

Memory 204 may store program instructions that are loadable and executable on the processor(s) 202, as well as data generated during execution of, and/or usable in conjunction with, these programs. In the illustrated example, memory 204 stores an operating system 212, which provides basic system functionality of the computing system 200 and, among other things, provides for operation of the other programs and modules of the computing system 200.

Memory 204 includes an access broker 214, which may be the same as or similar to the access broker 102 of FIG. 1. The access broker 214 is configured to broker application access to the device 216, which may be the same as or similar to one or both of the devices 112 and 114 of FIG. 1.

Memory 204 includes an application container component 218, which may be the same as or similar to the application container component 106 of FIG. 1. The application container component 218 is configured to enforce a secure execution mode that controls application access to system resources, such as to the device 112.

Memory 204 includes an application manifest 220, which may be the same as or similar to the application manifest 120 of FIG. 1. Memory 204 also includes a user interface consent module 222 and an operating system settings module 224, which may be the same as or similar to the user interface consent module 124 and the operating system settings module 130, respectively, of FIG. 1. The user interface consent module 222 and the operating system settings module 224 may be components within the operating system 212, but are shown separately in FIG. 2 for the sake of discussion.

Memory 204 includes a privileged permissions record 226, which may be the same as or similar to the privileged permissions record 126 in FIG. 1. Memory 204 also includes an application acquisition component 228, which may be the same as or similar to the application acquisition component 128 of FIG. 1.

### Exemplary Operations for Brokering Capability Access

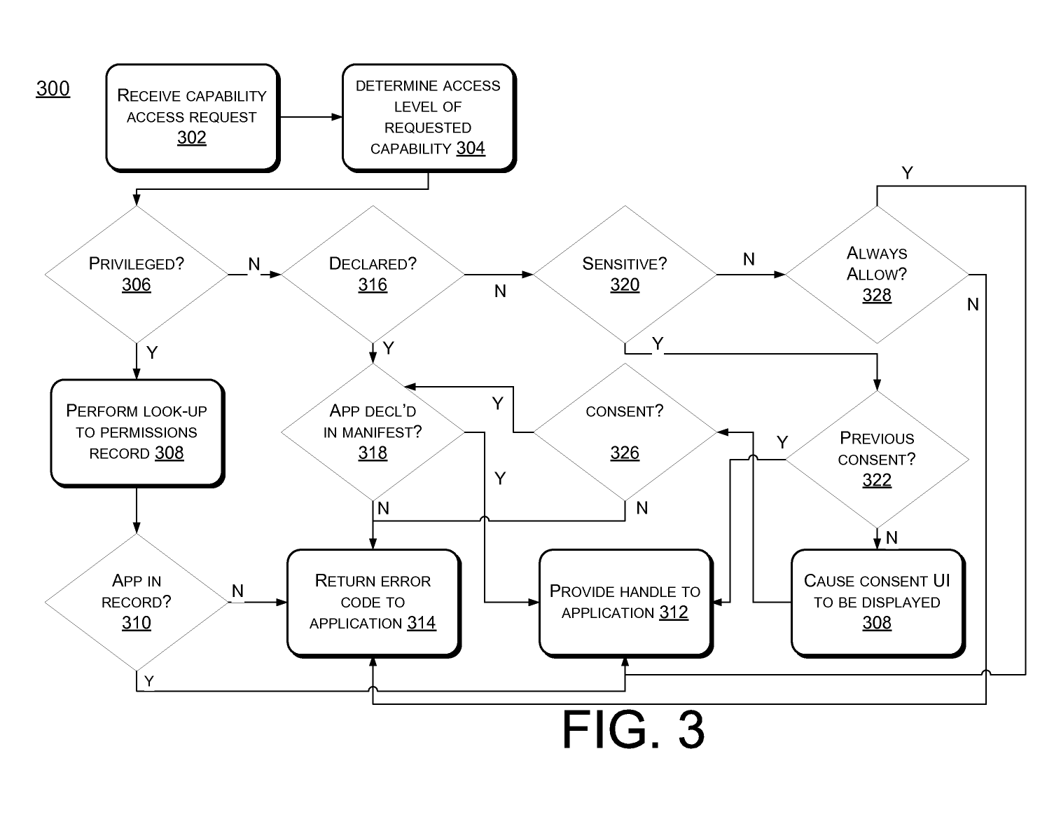

FIG. 3 is a flow diagram showing an example process 300 for brokering capability access based on application declarations and user consent. An access broker of a computing system receives a request from an application to access a capability, such as a device capability of a hardware device installed on the computing system, block 302. The application may be executing in a secure execution environment that controls access to system resources, such as memory, other applications, and installed hardware devices.

The access broker performs a look-up operation to a policy to determine a access level of the requested capability, block 304. Upon a determination that the policy indicates that the requested capability is a “privileged” capability or that the capability is an unknown capability, block 306, the access broker performs a look-up operation to a permissions record, block 308. The permissions record may be stored in a secure area of memory. The permissions record may include applications that are registered by device drivers as being permitted to access privileged capabilities.

Upon a determination that the application is listed in the permissions record as being allowed to access the requested capability, block 310, the access broker provides the application with a handle usable to interact with the requested capability, block 312. Upon a determination that the application is not listed in the permissions record as being permitted to access the requested capability, the access broker returns to the application an error code, thereby denying the application's request, block 314. (See U.S. application Ser. No. 13/099,260 filed by Ganapathy et al. on May 2, 2011 and entitled “BINDING APPLICATIONS TO DEVICE CAPABILITIES” for details regarding access brokering using privileged permission records.)

The access broker determines whether the requested capability falls under the “declared” capability level, block 316. The declared capability provides that the capability be included in the application's manifest in order for the capability access request to be granted to the application.

Upon a determination that the requested capability falls under the “declared” capability level, the access broker determines whether an application manifest of the application includes a declaration of the requested capability, block 318. The determination may include a look-up to the application manifest, or the application manifest declarations may be loaded into the access broker policy (or some other location) when the application is launched or at some other time. Upon a determination that the application manifest declares the requested capability, the access broker provides a handle to the application, block 312.

Upon a determination that the requested capability falls under the “sensitive/restricted” access level, block 320, the access broker determines whether there has been previous consent by the user to a previous request by the application to access the requested capability, block 322. In embodiments, the access broker further determines whether the previous request was received by the same instance of the application. If it is a new instance of the application, the previous consent may be considered invalid. In alternative embodiments, the access broker policy may provide that the user consent to each instance of an application requesting consent regardless of previous consent by the same or different instance of the application. Upon a determination that there has been previous consent, the access broker provides the application with a handle, block 312.

Upon a determination that there has been no previous consent, the access broker causes display of a user interface element of the operating system with a selectable option to consent to the capability access request, block 324. The user interface element includes information regarding the capability being requested. Because the user interface element appears in context of the user interacting with the application, the user can better understand when and why the application will access the capability. Upon receipt of input indicating user consent, block 326, the access broker determines whether the application manifest declares the requested capability, block 318 before providing a handle, block 312. In alternative embodiments, the access broker returns a handle without first determining whether the application manifest declares the requested capability. In still other embodiments, the access broker may be configured to call other operating system elements to determine whether access should be granted instead of, or in addition to, causing a consent user interface to be displayed.

Upon a determination that the requested capability falls under the “always allow” access level, block 328, the access broker provides the application with a handle, block 312.

In embodiments, the policy may indicate that one or more capabilities fall under multiple access levels. In one non-limiting example, a particular capability may be indicated in the policy as falling under both the “privileged” and “declare” access levels. In such cases the access broker may perform functions related to both block 308 and block 318 before providing a handle to the application to access the capability. The exact order and flow of operations shown in FIG. 3 is not to be taken as limiting unless otherwise indicated in the present Detailed Description or in the claims.

Exemplary Operations for Providing in-Application Capability Configuration

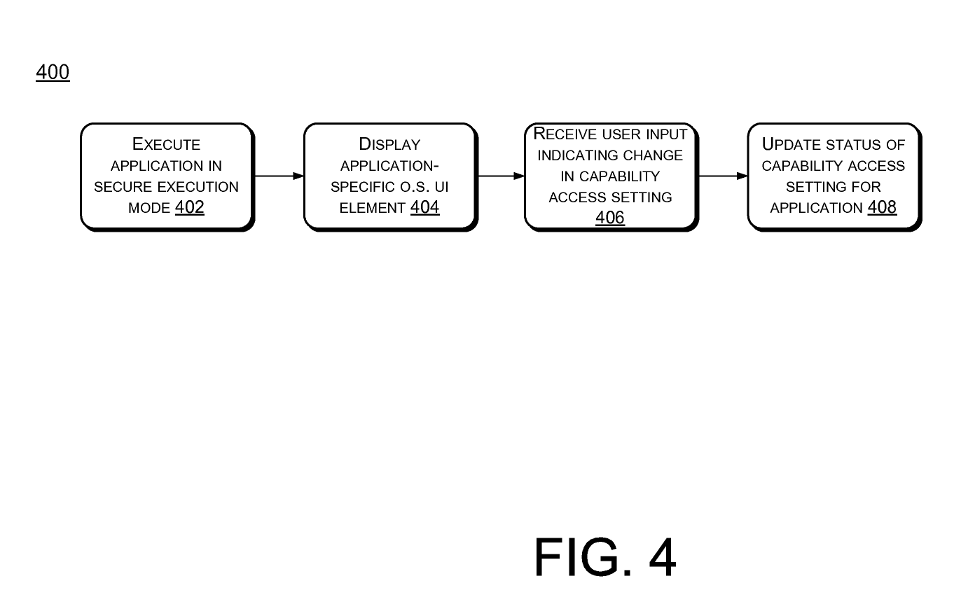

FIG. 4 is a flow diagram showing an example process 400 for providing in-application capabilities interface settings configuration. An application is executed in a secure execution mode (provided for example by an application container component), block 402. The secure execution mode provides control over the application's access to system resources.

An access broker receives, during execution of the application, input from a user input device indicating a command to display an application-specific operating system user interface element that includes a selectable option to change a capability access setting of the application, block 404. Because the user interface element is an operating system element, the user will have a greater measure of assurance and confidence that the operating system is appropriately controlling application access to capabilities, such as device capabilities.

An in-application user interface module receives user input indicating a command to change a capability access setting for the application, block 406. The command may be to disable or to enable the application's access to the capability. Receipt of a command to change the capability setting overrides any previous consent the user may have provided to allow the application to access the capability. The status of a capability access setting for the application is therefore updated in the access broker as well as in the capability-specific operating system settings module in order to reflect the change, block 408. At some later time, if the application requests access to that particular capability, the access broker may either deny the request or prompt the user for consent, as is described elsewhere within this Detailed Description.

### Exemplary Operations for Providing Capability-Specific Settings Configuration

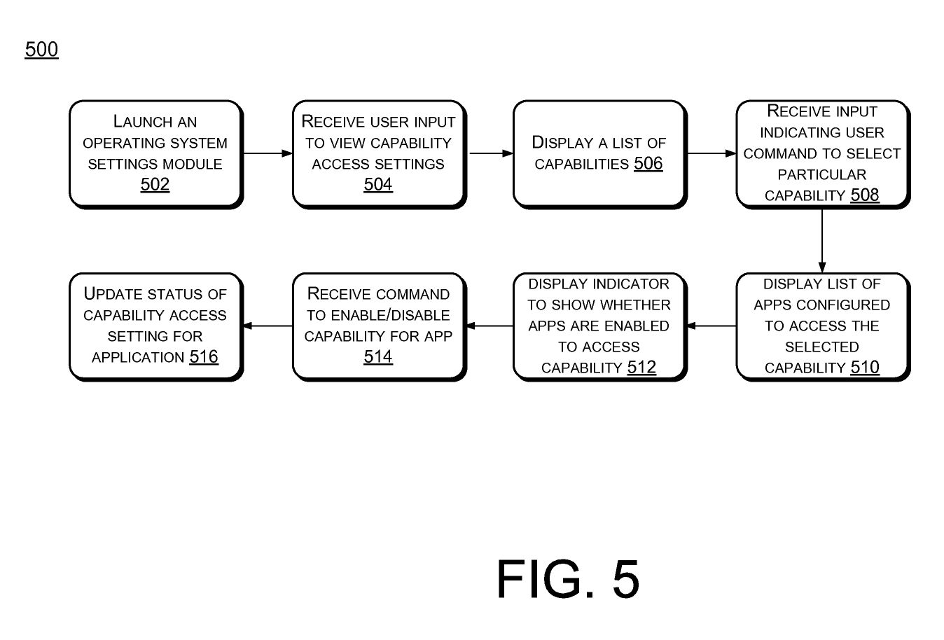

FIG. 5 is a flow diagram showing an example process 500 for viewing and configuring capability-specific settings, such as device capability-specific settings. A computing system launches an operating system settings module, block 502. This may provide a “control panel” type interface that provides access to various system settings, such as capability access settings including device capability settings.

The operating system settings module receives user input to view capability access settings, block 504. In response, the operating system settings module displays a list of capabilities, block 506. A particular capability may be selected by default.

The operating system settings module receives input indicating a user command to select a particular capability, block 508. In response to the input, the operating system settings module displays a list of applications that are configured to access the selected capability, block 510.

The operating system settings module also displays an indicator next to the applications to show whether the applications are currently enabled to access the capability, block 512. The applications may be enabled to access the capability due to prior user consent, due to application declaration, because the application is listed in a privileged permissions record, or for some other reason.

The operating system settings module receives input indicating a command to enable or disable the capability for a particular application, block 514. The input may be received via a user input device interacting with the display of the operating system settings module. For example, the input may be received during interaction with the indicator that is displayed to show whether the application is currently enabled to access the capability. Non-limiting examples of indicators include two button indicators (enabled/disabled, on/off, or other), a sliding control, a knob, or some other interactive indicator.

In response to a change in a capability access setting, the operating system settings module causes an update to an access broker of the computing system, block 516. If the user input indicates a disabling of the capability for that particular application, then the access broker either denies further requests by the application for access to that capability, or prompts the user for consent, as is described elsewhere within this Detailed Description.

FIGS. 3-5 depict flow graphs that show example processes in accordance with various embodiments. The operations of these processes are illustrated in individual blocks and summarized with reference to those blocks. The processes are illustrated as logical flow graphs, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, separated into sub-operations, and/or performed in parallel to implement the process. Processes according to various embodiments of the present disclosure may include only some or all of the operations depicted in the logical flow graphs.

### Exemplary User Interfaces

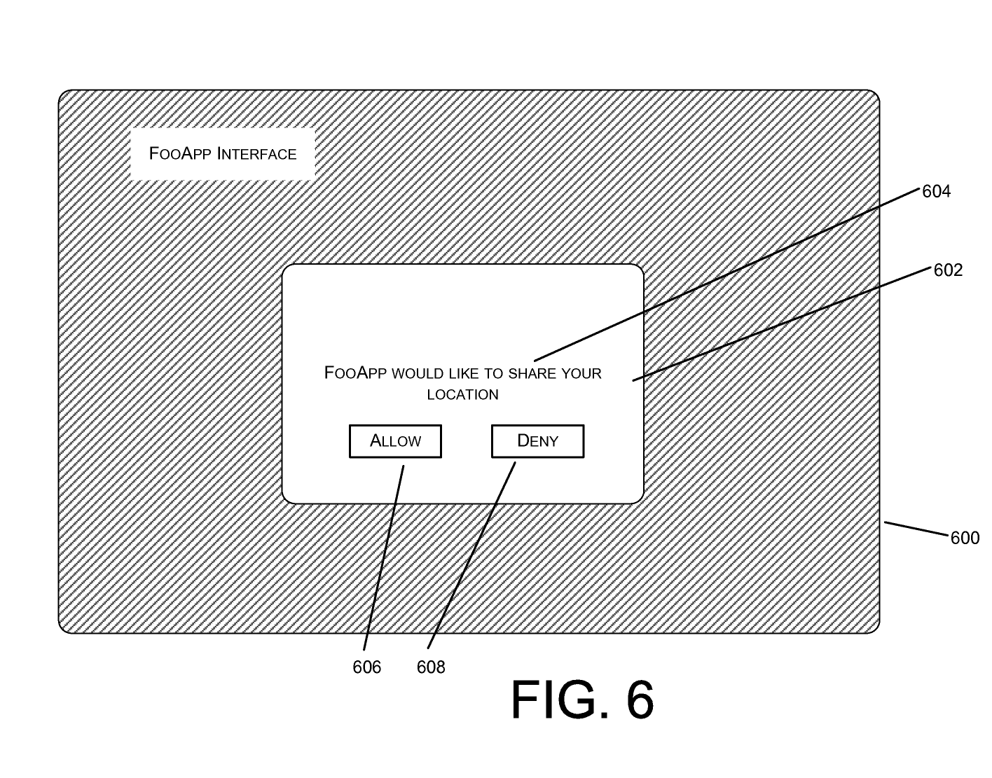

FIG. 6 illustrates an exemplary user interface display for obtaining user consent to an application request for a sensitive capability, such as a sensitive device capability. The application interface 600 represents any application that may be running within a user interface of the computing system (in this case, the application “FooApp”). Upon receipt of a request from the application to access a capability listed as “sensitive” in its policy, an access broker will cause display of a consent user interface element 602. The consent user interface element 602 includes a description 604 of the capability that the application is requesting, as well as a selectable option (the “allow” button 606) to consent to the request. In the example shown in FIG. 6, the application “FooApp” is requesting access to a location capability. In various embodiments, the location capability may be provided by a hardware device of the computing system—such as a GPS device. In other embodiments, the location capability may be provided by a web service or some other service other than a device of the computing system.

In the example shown in FIG. 6, a user may select the “allow” button 606 or “deny” button 608 to either consent to or deny the request. Because the consent user interface element 602 is displayed upon receipt of the request from the application to access the “sensitive” capability (in this example a location service), and in context of the user interaction with the application, the user is better able to determine when and why the application will use the location service. This may be because, for example, the user has initiated some functionality of the application that has caused the application to request the handle to the location services capability. And the user may therefore be better able to link his initiation of the function with his or her being requested to consent to the application's access of location services. For example, the application may allow the user to “check in” at a location so that his location is made available on a social networking site. Thus, when the user selects the application's “check in” function, he or she will be better able to understand that the application is requesting access to location services to further the “check in” functionality of the application.

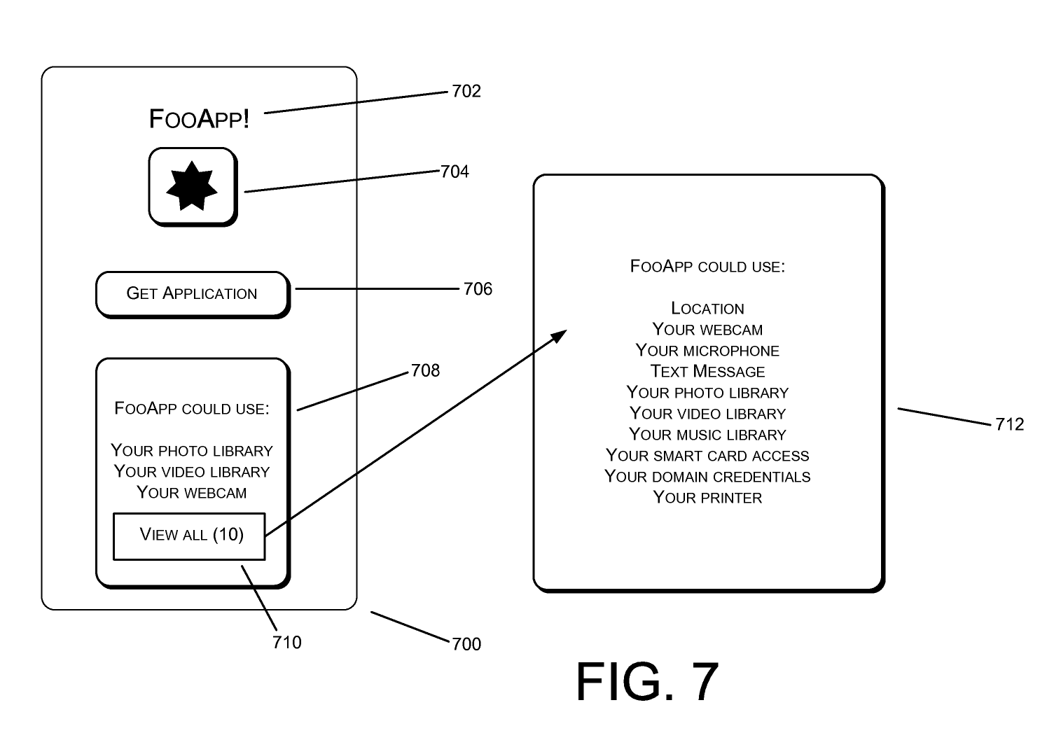

FIG. 7 illustrates an exemplary application acquisition user interface display including a display of capabilities, including device capabilities. User interface display 700 is displayed by an application acquisition service that is enabled to provide a user with the option to obtain, download, and/or install an application. The user interface display 700 includes one or more features such as an application name 702, an application icon graphic 704, and a selectable option 706 to download or purchase the application. The user interface display 700 includes a capabilities list 708 that displays one or more capabilities that the application is enabled to access. The capabilities list 708 may display application functions that include device capabilities, as well as other non-device capabilities such as a function to access the user's photo library. The capabilities list 708 may include only a subset of capabilities. Therefore, the capabilities list 708 includes a selectable option 710 to view a list 712 of all capabilities.

The user interface display 700 allows a user to better determine what capabilities an application is enabled to perform prior to the user purchasing, downloading, installing, and/or executing the application. The list 712 of all capabilities is declared in the application's manifest (not shown), and the user interface display 700 pulls the list 712 from the application's manifest. At some later time, after the user has obtained and executed the application, the application may request access to a capability. This request is received by an access broker. As is described elsewhere within this Detailed Description, the access broker may not allow the application to access the capability unless the capability is declared in the application manifest.

Presenting the capability declarations, including device capability declarations, from the application manifest at the time that the application is obtained, and enforcing a policy that requires the application to declare a capability in its manifest in order for the application to gain access to that capability, maintains continuity between those capabilities that are disclosed to the user and those capabilities that the application is allowed to use. This way, the application cannot hide functions to access capabilities from the user.

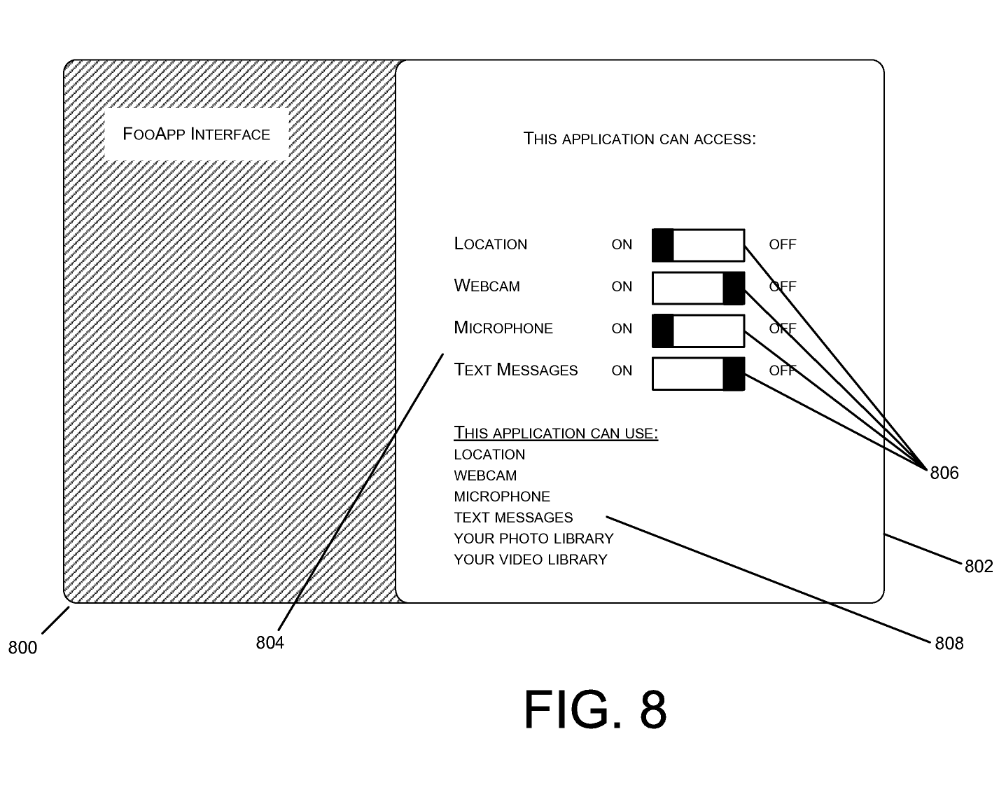

FIG. 8 illustrates an exemplary user interface display for displaying in-application capability settings information. An application interface 800 is overlaid partially by an in-application capability settings display window 802. The in-application capabilities settings display window 802 is an operating system user interface. The in-application capabilities settings display window 802 lists the capabilities 804 (some or all of which may be device capabilities) along with selectable controls 806 to enable or disable the capabilities 804. The in-application capabilities settings display window 802 also displays a list 808 of various capabilities that the application is configured to use or access, including various device capabilities. The list 808 is taken from an application manifest.

The in-application capabilities settings display window 802 allows the user to view all capabilities that the application is configured to access in a single location. This way, the user does not need to open multiple configuration settings windows to view this information. Also, because the in-application capabilities settings display window 802 can be accessed during interaction with the application, the user can more easily control the application's access to capabilities. Once an application's settings are changed via the in-application capabilities settings display window 802, an access broker is updated to reflect the current state of the application's access to that capability.

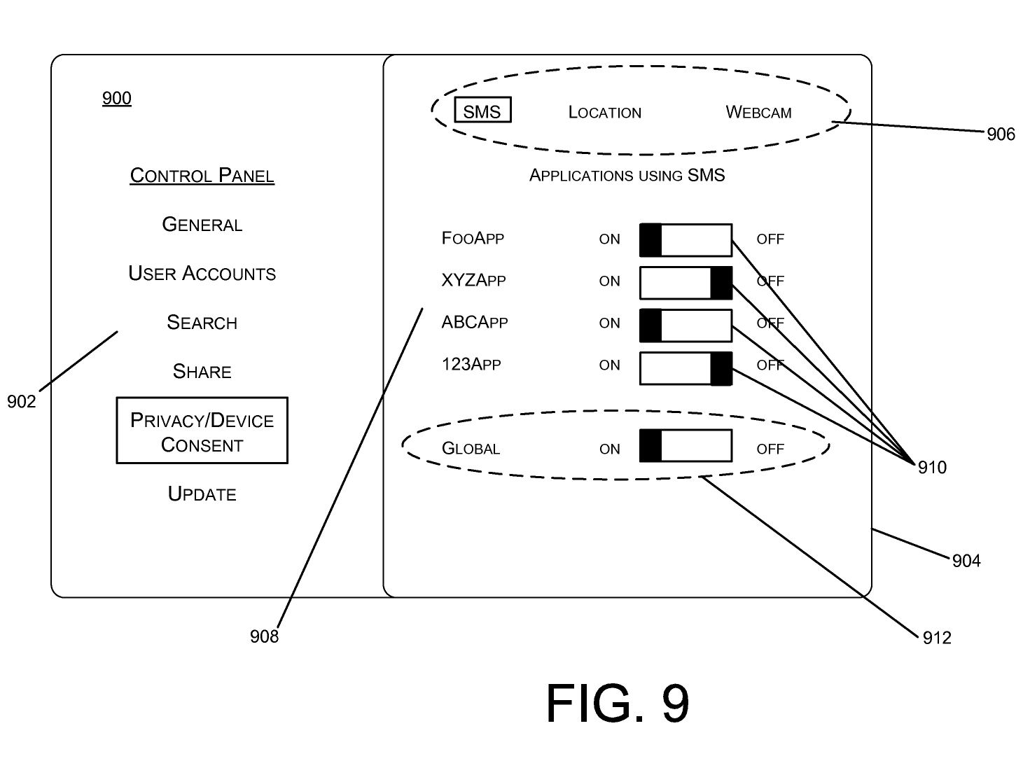

FIG. 9 illustrates an exemplary user interface display for displaying capability-specific settings information. An operating system settings display 900 includes a selectable list 902 of various settings that can be viewed, such as in the “privacy/device consent” settings window 904. The “privacy/device consent” settings window 904 includes a selectable list 906 of capabilities (shown in dashed circle). In the example shown in FIG. 9, the “SMS” capability is currently selected, thereby causing a list 908 of all applications that are configured to access the “SMS” function. Should the “location” capability be selected, for example, a different list would be presented showing all applications configured to access location services (which may or may not include the same applications as list 908). The list of capabilities in list 908 may include capabilities provided by devices, or by services other than devices.

The applications in list 908 are presented next to a selectable control 910 for disabling or enabling a particular application's access to the capability. The “privacy/device consent” settings window 904 may also include a global option 912 (shown in dashed circle) that is selectable to enable or disable the selected capability for all applications. The “privacy/device consent” settings window 904 may therefore allow a user to control access to a particular capability for a particular application or, alternatively, turn on or off that capability for all applications. Once an application's settings are changed via the operating system settings display 900, an access broker is updated to reflect the current state of the application's access to that capability.

FIGS. 6-9 illustrate various user interfaces. These user interfaces are presented for the sake of illustration, and their exact layouts and contents are not to be taken as limitations. Alternative layouts and contents can be used without departing from the scope of this Detailed Description.

### Computer-Readable Media

Depending on the configuration and type of computing device used, memory 204 of the computing system 200 in FIG. 2 may include volatile memory (such as random access memory (RAM)) and/or non-volatile memory (such as read-only memory (ROM), flash memory, etc.). Memory 204 may also include additional removable storage and/or non-removable storage including, but not limited to, flash memory, magnetic storage, optical storage, and/or tape storage that may provide non-volatile storage of computer-readable instructions, data structures, program modules, and other data for computing system 200.

Memory 204 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### CONCLUSION

Although the disclosure uses language that is specific to structural features and/or methodological acts, the invention is not limited to the specific features or acts described. Rather, the specific features and acts are disclosed as illustrative forms of implementing the invention.

What is claimed is:

1. A method comprising:
receiving, by an access broker of computing system from an application of the computing system, a request for access to a capability of available functionality of the computing system;
accessing, by the access broker in response to the request, capability declarations associated with an application manifest of the application; and
granting, by the access broker, the request based at least in part on a determination that the capability declarations include a declaration indicating that the application includes a function configured to access the capability.

2. The method of claim 1, wherein the granting includes providing, by the access broker, an interface handle to the application, the interface handle usable to interact with the capability of a function of the computing system.

3. The method of claim 1, further comprising:
determining, by the access broker, that a policy of the access broker includes an indication that a grant of access to the capability requires user consent;
causing, by the access broker in response to the determining, display of a user interface element of an operating system of the computing system, the user interface element having a selectable option to consent to the request; and
wherein the granting is further based at least in part on receipt of input indicating user consent to the request.

4. The method of claim 1, further comprising:
determining, by the access broker, that a policy of the access broker includes an indication that a grant of access to the capability requires user consent;
wherein the granting of the request is further based at least in part on a determination that input indicating user consent to a previous request by the application for access to the capability was received prior to the receipt of the request.

5. The method of claim 4, wherein the granting of the request is further based at least in part on whether the previous request was received from a current instance of the application.

6. The method of claim 1, further comprising:
determining, by the access broker, that a policy of the access broker includes an indication that a grant of access to the capability requires user consent;
wherein the granting of the request is further based at least in part on a determination that input indicating user consent for access to the capability was received via an operating system settings module.

7. The method of claim 1, further comprising executing the application in a secure execution mode, wherein the secure execution mode provides that requests for application access to certain capabilities are brokered by the access broker.

8. A computing system comprising:
one or more processors;
a hardware device installed on the computing system;
a function of the computing system;
a user consent component executable by the one or more processors and configured to display user interface elements; and
an access broker executable by the one or more processors and configured to cause, in response to receipt of a request from an application of the computing system to access a device capability of the hardware device, the user consent component to display a user interface element with a selectable option to consent to the request upon a determination, by the access broker, that a broker policy of the computing system includes an indication that access to the capability of the hardware device.

9. The computing system of claim 8, wherein the access broker is further configured to provide to the application an interface handle usable to access the capability based at least in part on receipt of input that indicates user consent to the request.

10. The computing system of claim 8, wherein the access broker is configured to grant the request upon a determination that input indicating user consent to a previous request to access the hardware device capability was received prior to receipt of the request.

11. The computing system of claim 8, further comprising an application manifest of the application stored in a memory of the computing system, and wherein the access broker is configured to return an interface handle, to the application, based on receipt of input indicating user consent to the request and a determination that the application manifest includes a declaration that indicates that the application includes a function for accessing the capability.

12. The computing system of claim 11, further comprising an application acquisition module executable by the one or more processors and configured to display an application acquisition interface with a selectable option to acquire the application, wherein the application acquisition interface displays one or more declarations from the application manifest including the declaration that indicates that the application includes the function for accessing the capability.

13. The computing system of claim 8, further comprising an application container component configured to enforce execution of the application by the one or more processors in a secure execution mode that provides that requests to access certain capabilities are to be brokered by the access broker.

14. Computer-readable media comprising a plurality of programming instructions executable by one or more processors of a computing system to perform a method, the method comprising:
displaying, during execution of an application in response to input from a user input device, an application-specific operating system user interface element that includes a selectable option to change a capability access setting of the application; and
upon receipt of input from a user input device indicating that the selectable option is selected, updating an access broker to change the capability access setting of the application.

15. The computer-readable media of claim 14, wherein the method further comprises:
receiving, by the access broker, a request from the application to access a capability associated with the capability access setting of the application; and
providing, by the access broker, the application with an interface handle usable to access the capability, the providing occurring upon a determination that the capability access setting of the application indicates user consent for the application to access the capability.

16. The computer-readable media of claim 14, wherein the method further comprises:
receiving, by the access broker, a request from the application to access a capability associated with the capability access setting of the application; and
providing, by the access broker, the application with an error message denying access to the capability upon a determination that the capability access setting of the application indicates user denial of consent for the application to access the capability.

17. The computer-readable media of claim 14, wherein the method further comprises:
receiving a request from another application to access a capability associated with the capability access setting of the application; and
upon a determination that a policy of the computing system requires user consent to access the capability and a determination that no input is previously received indicating user consent for the other application to access the capability, causing display of a user interface element including a selectable option to consent to the other application's request for access to the capability.

18. The computer-readable media of claim 17, wherein the method further comprises providing the other application with a handle usable to access the capability upon receipt of input indicating user consent to the other application's access to the capability.

19. The computer-readable media of claim 14, wherein the method further comprises:
receiving, by an access broker, a request from the application to access another capability; and
upon a determination that a policy of the computing system requires user consent to access the other capability and a determination that there is no prior user consent for the application to access the other capability, causing display of a user interface element with a selectable option to consent to the application's request for access to the other capability.

20. The computer-readable media of claim 14, wherein the method further comprises:
executing an operating system settings module including display of a user interface element that includes a list of applications enabled to access a capability associated with the capability access setting of the application;
changing the capability access setting of the application in response to receipt of input from a user input device interacting with a selectable option to change the capability access setting.
